(19) United States
(12) Patent Application Publication
(10) Pub. No.: US 2020/0076742 A1
(43) Pub. Date: Mar. 5, 2020

(54) SENDING DATA USING A PLURALITY OF CREDIT POOLS AT THE RECEIVERS

(71) Applicant: Hewlett Packard Enterprise Development LP, Houston, TX (US)

(72) Inventors: Nicholas George McDonald, Ft. Collins, CO (US); Darel Neal Emmot, Wellington, CO (US)

(21) Appl. No.: 16/115,121

(22) Filed: Aug. 28, 2018

(51) Int. Cl. H04L 12/801; H04L 12/835; H04L 12/851; H04L 12/925; H04L 12/915; H04L 12/861

(52) U.S. Cl. CPC H04L 47/39; H04L 47/30; H04L 47/24; H04L 49/9084; H04L 47/786; H04L 49/9036; H04L 47/722

(57) ABSTRACT

Examples relate to methods for sending data between a senders and receivers coupled by a link. These methods comprise allocating a plurality of credit pools in a buffer on the receiver. These credits represent a portion of memory space in the buffer to store data received from the sender. Then, the sender allocates a number of credits from a plurality of credits to each virtual channel. A number of virtual channels from the plurality of virtual channels is mapped to the credit pools. The sender sends a data block to the receiver through a particular virtual channel when there are enough credits available in at least one of the particular virtual channel and the data pool to which the particular virtual channel is mapped. The sender decrements a credit counter associated with the corresponding at least one of the particular virtual channel and the data pool.

### BACKGROUND

For large-scale interconnection networks the use of dynamic buffer allocation has been widely used to support a plurality of virtual channels (VCs) and/or long channel latencies. Traditional dynamic buffer allocation may cause link under-utilization in the event of un-even VC usage because the management of credits is performed at the receiver. Some modern implementations perform credit management at the sender and have one single shared pool of credits at the receiver that may provoke that some particular VC transmitting at higher rates may steal all the credits from the single shared pool thus negatively effecting other VCs.

### BRIEF DESCRIPTION OF THE DRAWINGS

FIG. 1 is a flowchart of an example method for sending data blocks using a plurality of credit pools at the receiver and a dynamic buffer allocation mechanism.

FIG. 2 is a flowchart of an example method for managing credit decrease in the credit counters residing in the sender.

FIG. 3 is a flowchart of an example method for managing credit increase in the credit counters residing in the sender.

FIG. 4 is a block diagram of an example system for sending data blocks using a plurality of credit pools at the receiver and a dynamic buffer allocation mechanism.

FIG. 5 is a block diagram of an example system for sending data blocks using a plurality of credit pools at the receiver and a dynamic buffer allocation mechanism and including a machine-readable storage medium that stores instructions to be executed by the sender.

### DETAILED DESCRIPTION

Examples disclosed herein refer to methods for sending data between a sender and a receiver coupled by a link using a plurality of credit pools at the receiver and dynamic buffer allocation mechanisms. The sender and the receiver may be, for example, interconnected routers or switches forming a network. The sender sends out information and the receiver receives incoming information. The network may have other devices, such as mass storage devices, servers or workstations, connected to. Any devices connecting to a network can communicate with any other devices connected to the network. A direct connection between two devices is a link. The devices may comprise ports as interfaces with the link that interconnect them.

There may be buffer memories associated with the ports of the sender and the receiver, to temporarily store the information in transit before the information is acknowledged to be transmitted towards its destination, or to be stored or used by a device at its destination. The buffer memory may be divided into memory units. One memory unit, which can store one data block, is represented by one credit. Thus, credits represent portions of memory space in the buffer in the receiver reserved to store data received from the sender.

As used herein, VCs may refer to virtual sharing of a physical channel. These VCs can be used for network deadlock avoidance, protocol deadlock avoidance, reducing head-of-line blocking by increasing control flow resources, and segregation of traffic classes.

As used herein, a dynamic buffer allocation mechanism may refer to mechanisms that employ pure virtualization to having multiple VCs. Instead of each VC having its own buffering area, a dynamic approach has a single buffer that is virtually divided, e.g., using linked lists. As used herein, VCs may refer to virtual divisions of buffer memory where each virtual division is able to make forward progress independently. The buffer space or credits available at the buffer memory of the receiver may be allocated among the VCs.

These methods for sending data between a sender and a receiver coupled by a link and using dynamic buffer allocation mechanisms comprise allocating a plurality of independent credit pools in the buffer on the receiver. More particularly, the methods may allocate a plurality of independent credit pools in the buffer associated with the input port in the receiver through which the link interconnects the sender and the receiver. As used herein, credit pools may refer to pools of buffer space which can be used by any VC of the link interconnecting the devices.

In some examples, upon initialization of the sender and the receiver, the receiver may provide the sender an indication of the total amount of space available in the buffer represented by the number of credits available. In addition, a network controller in charge of management of the network and that may comprise an interface to interact with an administrator user, may inform the receiver of the number of credit pools to be allocated in the buffer and a respective amount of credits to be allocated in each credit pool.

The methods further comprise allocating, by the sender, a number of credits from a plurality of credits to each VC of the plurality of VCs in which the link connecting the sender and the receiver may be divided. In this way, each VC has a pre-assigned amount of space to be dynamically reserved in the buffer. Depending on the size of the data blocks to be sent by the sender to the receiver, at least one credit in the buffer may be required to store the transmitted data blocks. A data block might be a flit, byte, frame, etc. In some examples in which data blocks are bigger than credits, the sender may comprise a chunk generator module to divide data blocks into data chunks with a size that fits into a credit.

In some examples, the dynamic buffer allocation mechanism uses a credit-based flow mechanism to keep track of the use of the buffer space in the receiver. For example, the sender may initialize credit counters to the number of credits allocated to each VC, to the number of credits available in each credit pool, or to the sum of the credits available for a VC including the credits allocated to each VC and the credits of the corresponding credit pool. Then, both the sender and the receiver keep track of the use of the buffer space using the number of credits and credit counters.

Then, the methods may map a number of VCs from the plurality of VCs to the independent credit pools. For example, an administrator user via the network controller may inform the sender of the mapping between VCs and credit pools. With such a mapping, a particular VC mapped to a particular credit pool may have access to the credits allocated to the VC itself and to the credits allocated to the particular pool. Since the credit pools are independent to each other, VCs mapped to a particular credit pool do not have access to credits allocated into any other credit pool in the buffer. In this way, if a particular VC attempts to send a great amount of data, it will only be able to use the credits that correspond to itself and its credit pool while the rest of VCs mapping to the same shared credit pool still have their own credits available and the rest of VCs mapping to different credits pools will remain unaffected. In some examples, each VC is given a minimum size of one maximum size data block to avoid deadlocks.

While in some examples the sender may map every VC to a respective credit pool, in some other examples, some of the VCs may not be mapped to any of the credit pools such that these un-mapped VCs could be used for management operations or remain free of dependencies on other VCs in the link.

Then, when the sender determines the particular VC to be used to forward the data block to the receiver and there are enough credits available in at least one of the particular VC and/or the credit pool to which the particular VC is mapped to, the sender may send the data block to the receiver through a particular VC. For example, the sender may check the sum of credits available for the VC and credits available for the credit pool to which the particular VC is mapped and evaluate whether this sum of available credits is enough to send the data block. In some examples in which the sender determines that there are enough credits available in the VC for sending the packet, only credits of the VC may be consumed. Alternatively, if the sender determines that there are enough credits available in the credit pool for sending the packet, only credits of the credit pool may be consumed. In some other examples in which the sender determines that there are credits available in the VC and the credit pool but these credits are not enough when considered independently to send the data block, credits from both, the VC and the credit pool may be consumed.

After that, the sender may decrement the credit counter associated with the corresponding at least one of the particular virtual channel and the credit pool to which the particular virtual channel is mapped. These credit counters may be located in the sender. Therefore, depending on where the credits have been consumed, from the VC and/or the credit pool, the credit counter associated with the particular VC and/or the particular credit pool will be decremented accordingly.

In some examples, the sender may map each VC of the plurality of VCs to a particular traffic class. As used herein, a “traffic class” may refer to different categories in which network traffic is categorized depending on different parameters and based on a predetermined policy may be applied to them to either guarantee certain Quality of Service (QoS) or to provide best-effort delivery. The network may comprise a network scheduler to categorize network traffic into different traffic classes according to various parameters, such as a port number, protocol, priority, etc. In turn, the sender may assign certain traffic classes to certain VCs such that data blocks pertaining to a particular traffic class is forwarded to the receiver through the corresponding VC. In such examples, if a particular VC assigned to a particular traffic class attempts to transmit data at a high rate it will only be able to use the credits that correspond to itself and its shared pool. Another VC in another traffic class will be unaffected by this, thus preserving traffic class isolation.

In the following description, for purposes of explanation, numerous specific details are set forth in order to provide a thorough understanding of the present devices and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

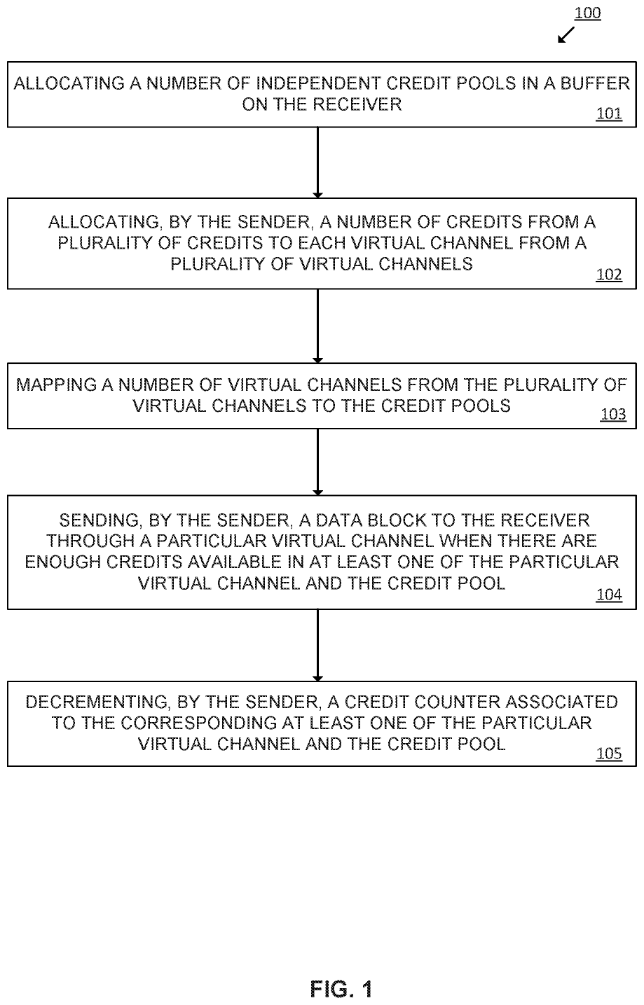

Turning now to the figures, FIG. 1 is a flowchart of an example for sending data blocks between a sender and a receiver coupled by a link and using a plurality of credit pools and dynamic buffer allocation mechanisms. In such example the link interconnecting the sender and the receiver is divided into a plurality of VCs.

At step 101 of the method 100, a plurality of independent credit pools are allocated by the sender in the buffer on the receiver. The buffer corresponds to the buffer memory associated with the input port on the receiver through which communication with the sender is performed. The number of credit pools and the number of credits assigned to each credit pool is defined by a network controller coupled to at least the receiver and that is managed by an administrator user.

At step 102 of the method 100, the sender allocates a number of credits from a plurality of credits in the buffer to each VC. The sender may allocate the same number of credits to each VC or may allocate a different number of credits to the VCs depending on pre-established policies, priorities, etc. In some examples, a minimum of credits could be defined by the administrator user via the network controller to be allocated to each VC.

At step 103 of the method 100, a number of VCs from the plurality of VCs in which the link is divided is mapped to the credit pools. In such a way, a data block using a particular VC of the number of VCs mapped to a credit pool can consume credits from the VC or the corresponding credit pool when it is sent to the receiver. In some examples, all the VCs can be mapped to the corresponding credit pools. In some other examples, some of the VCs can be mapped to the credit pools while some other VCs can remain unmapped and be used, for example, for management operations or for insuring forward progress by avoiding dependencies with other VCs.

At step 104 of the method 100, the sender, after having determined the particular VC, among all the possible VCs, to be used to transmit the data block and when there are enough credits available in at least one of the particular VC and the credit pool to which the particular VC is mapped, transmits the data block to the receiver through the particular VC. In some examples, there is a single credit counter residing in the sender per VC that corresponds to the sum of the credits available in the VC and in the credit pool the VC is mapped to. In some other examples, there are independent credits counters residing in the sender associated with the credits available in each VC and in each credit pool, respectively.

At step 105 of the method 100, the sender decrements the credit counter associated with the particular VC used to send the data block or the credit counter associated with the credit pool the particular VC is mapped to. In those examples in which there is a single credit counter residing in the sender per VC that corresponds to the sum of the credits available in the VC and in the credit pool, the sender decrements the credit counter associated with the particular VC.

Each time a data block is received at the receiver, the data block is stored in a buffer space and a credit counter residing in the receiver is increased by one. Thus, while the sender keeps track of this data block transmission by reducing the corresponding credit counter, which indicates the amount of additional data blocks that can be transmitted, the receiver increments its credit counter, which indicates amount of data blocks already stored in the buffer. When a data block in the buffer on the receiver is forwarded towards its destination or processed in the receiver or in any other device, the buffer space is freed to be used to store a new data block. At that time, a credit is sent by the receiver back to the sender and the credit counter in the receiver is decreased by one. When the sender receives this credit, the corresponding credit counter in the sender is increased by one. Besides, when the receiver receives a data block it knows which VC the data block should be virtually placed in. When the packet leaves that VC to continue on in the network the receiver will send the corresponding credits back to the sender tagged with that VC. In this way, the sender can easily identify the credit counter of the corresponding VC to which the received credits are to be added.

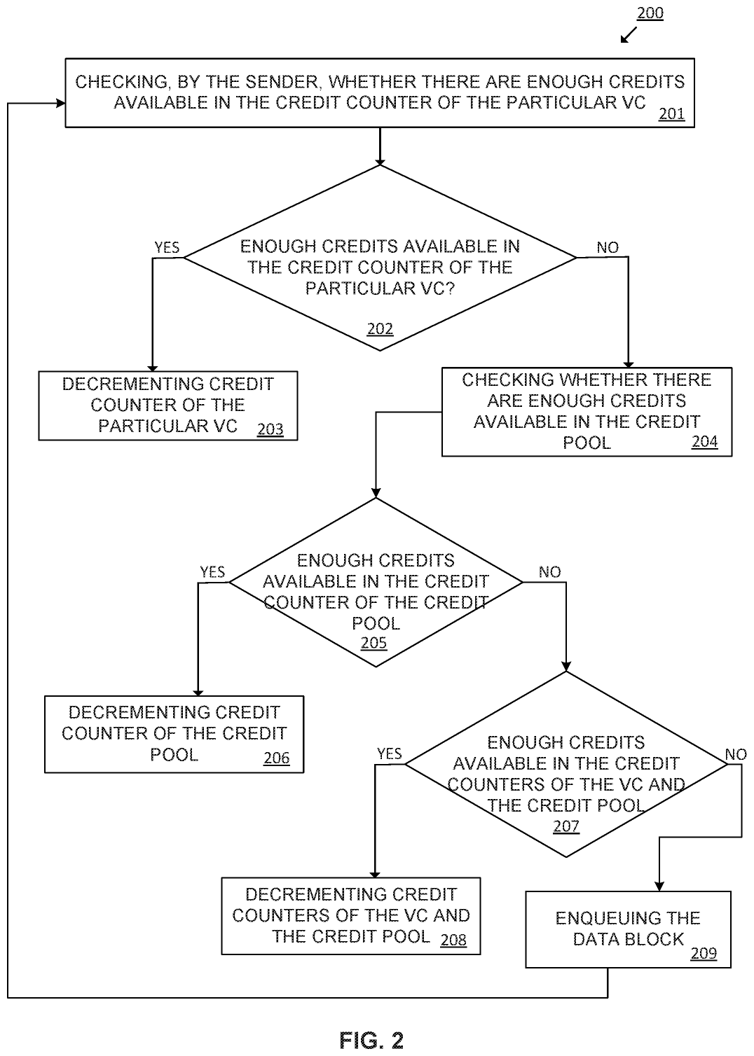

FIG. 2 is a flowchart of an example method 200 for managing credit decreases in the credit counters residing in the sender. In such example, the sender implements credit counters for the VCs and the credit pools independent from each other. Thus, the sender implements and manages one credit counter per VC and one credit counter per credit pool.

At step 201 of the method 200, the sender checks whether there are enough credits available in a first credit counter associated with the particular VC for sending the data block. If the sender determines, at step 202 of the method 200, that there are enough credits available in this first credit counter, the sender transmits the data block to the receiver. Then, at step 203 of the method 200, the sender decrements the corresponding credits from the first credit counter.

However, if the sender determines, at step 202 of the method 200, that there are not enough credits available in the first credit counter for sending the data block, then the sender, at step 204 of the method 200, checks whether there are enough credits available in a second credit counter associated with the credit pool to which the particular VC is mapped. If the sender determines, at step 205 of the method 200, that there are enough credits available in the credit counter associated with this credit pool, then the sender transmits the data block to the receiver. Then, at step 206 of the method 200, the sender decrements the corresponding credits from this second credit counter.

If the sender determines, at step 205 of the method 200, that there are not enough credits available in the second credit counter either, then the sender, at step 207 of the method 200, checks whether the sum of credits available in the first and second credit counters is enough for sending the data block. If the sender determines, at step 207 of the method 200, that there are enough credits available adding the credits available in the first and second credit counters, the sender transmits the data block to the receiver. Then, at step 208 of the method 200, the sender decrements the corresponding credits from the first and second credit counters.

If the sender determines, at step 207 of the method 200, that the sum of credits available in the first and second credit counters is not enough for sending the data block, then the sender, at step 209 of the method 200, enqueues the data packet in a buffer in the sender until some space is freed in the buffer on the receiver and some additional credits are available for sending data blocks. When this happen, the method 200 is executed again. In some other examples, the order in which credits are checked in the credit counters associated with the VC and/or the credit pools could be different.

In some other examples, the sender may implement a third credit counter for each VC with the sum of credits available in the VC and in the credit pool to which the VC is mapped. In such examples, the sender decrements the corresponding credits from this the third credit counter associated with the particular VC.

In some examples, if the sender determines that there are credits available into the particular VC though which the data block is to be transmitted and/or in the credit pool to which the particular VC is mapped but these available credits are insufficient to transmit the entire data block, the sender may implement a flit level flow control to allow a portion of the data block corresponding to the amount of credits available in the particular virtual channel and/or the credit pool to be sent to the receiver. For example, the data chunk generator may split the data block into chunks such that at least on chunk may be forwarded to the received consuming the available credits.

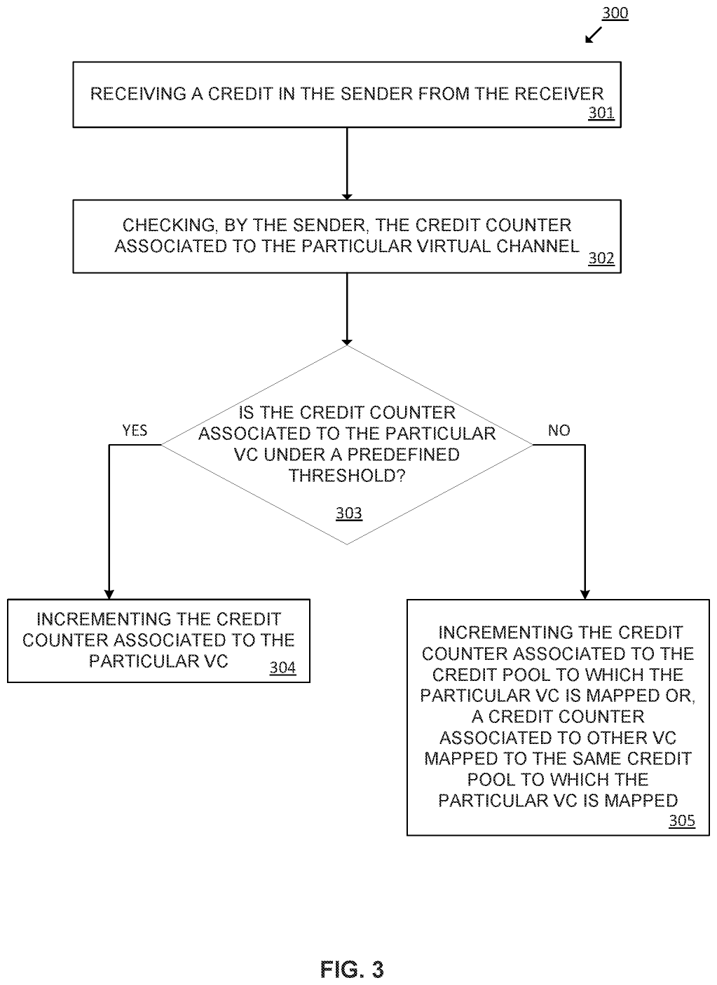

FIG. 3 is a flowchart of an example method 300 for managing credit increases in the credit counters residing in the sender. When one of the data block stored in the buffer on the receiver is forwarded towards its destination or processed in the receiver or in any other device, the buffer space occupied by said data block is freed. Then, the receiver sends a credit back to the sender and the credit counter in the receiver is decreased by one. In such example, the sender implements credit counters for the VCs and the credit pools independent from each other. Thus, the sender implements and manages one credit counter per VC and one credit counter per credit pool.

At step 301 of the method 300, the sender receives the credit sent by the receiver in response to one of the stored data blocks leaving the buffer in the receiver. The receiver may have tagged this credit with the particular VC through which the associated data block had been previously sent by the sender to the receiver.

At step 302 of the method 300, the sender checks the credit counter associated with the particular VC through which the data block was previously sent to the receiver.

At step 303 of the method 300, the sender determines whether the credit counter associated with the particular VC is under a pre-defined threshold. This pre-threshold may be determined by the administrator user via the network controller. The threshold may be the same for all the VCs in a link or may be different for each VC. When the sender determines that the credit counter associated with the particular VC is under the pre-defined threshold, the sender, at step 304 of method 300, increments this credit counter.

At step 305 of the method 300, when the sender determines that the credit counter associated with the particular VC is equal or above the pre-defined threshold, the sender may increment the credit counter associated with the credit pool to which the particular VC is mapped. Alternatively, the sender may increment a credit counter associated with other virtual channel mapped to the same credit pool to which the particular VC is mapped.

In some other examples in which the sender implements one single credit counter per VC for the sum of the credits available in the VC and in the respective credit pools, and thus, the sender implements and manages one single credit counter per VC, the sender checks whether the credit counter associated with the particular VC is under a pre-defined threshold and when this credit counter is under the pre-defined threshold, then it directly increments the credit counter associated with the particular VC through which the data block was previously sent to the receiver. When the credit counter associated with the particular VC is equal or above the pre-defined threshold the sender may increment a credit counter associated with other virtual channel mapped to the same credit pool to which the particular VC is mapped. If there are no other virtual channel mapped to the same credit pool, then the sender may increment the credit counter associated with the particular VC through which the data block was previously sent to the receiver.

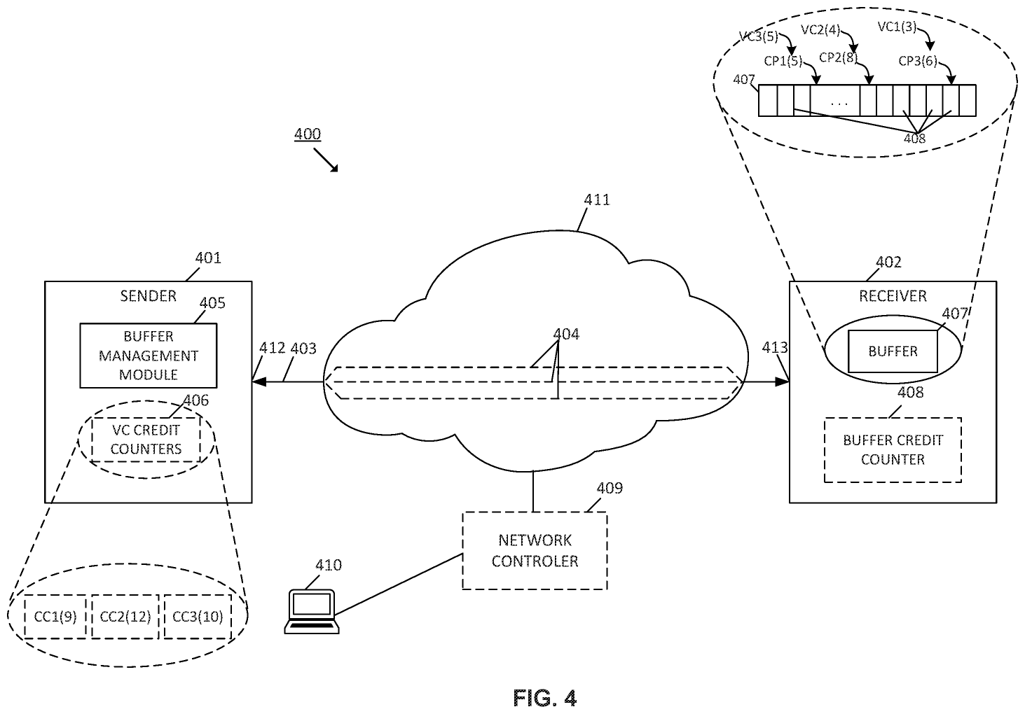

FIG. 4 is a block diagram of an example system 400 for sending data blocks using a plurality of credit pools at the receiver 402 and a dynamic buffer allocation mechanism. It should be understood that the example system 400 depicted in FIG. 4 may include additional components and that some of the components described herein may be removed and/or modified without departing from a scope of the example system 400. Additionally, implementation of system 400 is not limited to such example.

The system 400 comprises a sender 401 connected to a receiver 403 through a link 403 in a network 411. In such example, the link 403 is virtually divided into three VCs 404. In some other examples, the link 403 may be virtually divided in any number of VCs. The sender 401 comprises a buffer management module 405 to manage a buffer 407 on the receiver 402. The sender 401 comprises one output port 412 and the receiver one input port 413, to which the buffer 407 is associated, to act as interfaces with the link 403 that interconnects them. The sender and receiver may comprise additional ports (not shown in this figure) to interact with other devices within the network 411. The sender 401 may further comprise a buffer (not shown in this figure) associated with its output port 412 where data blocks are temporary stored until they are forwarded to their destination.

The system 400 comprises a network controller 409 in charge of management of the network 411 and that comprises an interface to interact with an administrator user 410. This network controller 409 informs the receiver 401 of the number of credit pools to be allocated in the buffer 407 and the respective amount of credits to be allocated in each credit pool. In such example, the network controller determines that three credit pools are to be allocated into the buffer 407, in particular CP1, CP2 and CP3, and that five credits are to be dynamically assigned to CP1, eight credits to CP2 and six credits to CP3. These credits 408 represent portions of memory space in the buffer 407 reserved to store data received from the sender 401.

The buffer management module 405 includes hardware and software logic to allocate, for example, three credits to VC1, four credits to VC2 and five credits to VC3. The buffer management module 405 also maps VC1 to CP3, VC2 to CP2 and VC3 to CP1. In such a way, a data block being sent via VC1 can consume credits from VC1 and/or CP3, a data block being sent via VC2 can consume credits from VC2 and/or CP2 and a data block being sent via VC3 can consume credits from VC3 and/or CP1. These credits pools are independent form each other, such that data blocks sent via a particular VC can consume credits from the particular VC and the corresponding credit pool the particular VC is mapped to, but they cannot consume credits form other Vs or credit pools.

The sender 401 also comprise VC credit counters 406 associated with the VCs 404 representing the sum of the credits available in the corresponding VC 404 and the respective credit pool to which it is mapped. The VC credit counters 406 represent the number credits available to use these VCs to send data blocks from the sender 401 to the receiver 402. In such example, the sender 401 will have three credit counters 406, CC1 associated with VC1 and representing nine credits, CC2 associated with VC2 and representing twelve credits and CC3 associated with VC3 and representing ten credits. The receiver 402 also implements a buffer credit counter 408 representing the number of data blocks stored in the buffer 407.

For example, when the buffer management module 405 determines that a data block is to be transmitted using VC1 to the receiver 402, the buffer management module 405 checks whether there are enough credits available in the CC1 associated with VC1. When there are enough credits in CC1, e.g. the data block has a size corresponding to one credit and the CC1 has nine available credits, the buffer management module 405 transmits the data block to the receiver VC1 and decrements CC1 in one credit. When the receiver 402 receives the data block, it knows that the data block is to be virtually placed in VC1 or CP3 in the buffer 407. The credit decremented from CC1 is sent to the receiver 402 that increments its buffer credit counter 408 in one credit, which indicates that the buffer 407 is storing one data block. When this data block leaves the buffer 407, and more particularly VC1, to continue on in the network the receiver 402 will send the credit back to the sender tagged with that VC1. Thus, the sender, upon reception of the tagged credit, will increase CC1 in one credit.

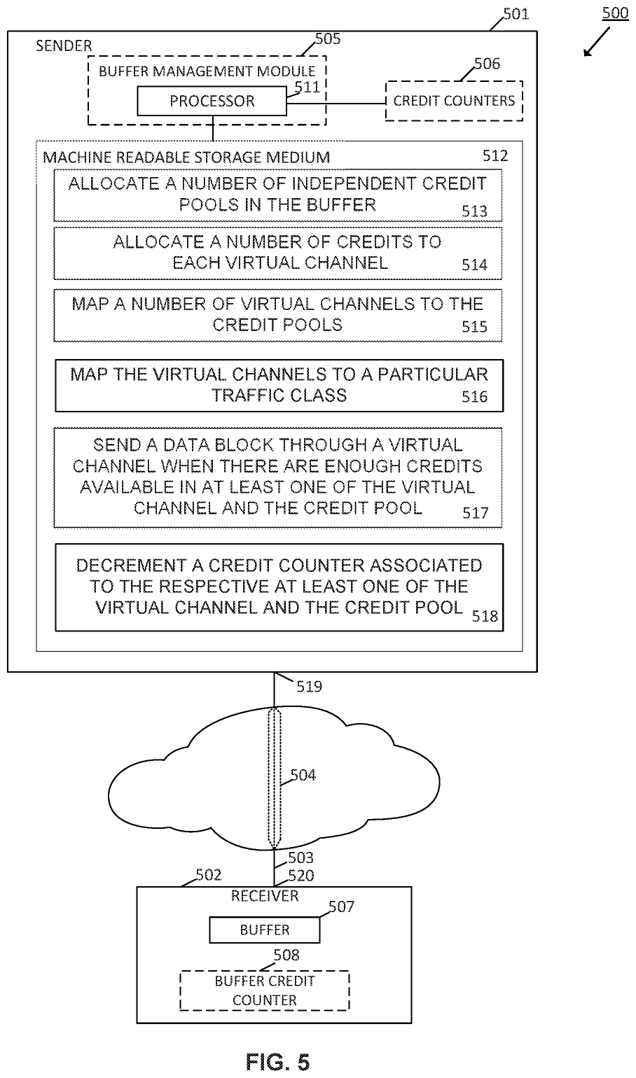

FIG. 5 is a block diagram of an example system 500 for sending data blocks using a plurality of credit pools at the receiver 502 and a dynamic buffer allocation mechanism and including a machine-readable storage medium 512 that stores instructions 513-518 to be executed by the processor 511 in the buffer management module 505 in the sender 501. It should be understood that the example system 500 depicted in FIG. 5 may include additional components and that some of the components described herein may be removed and/or modified without departing from a scope of the example system 500. Additionally, implementation of system 500 is not limited to such example.

The sender 501 is depicted as including a buffer management module 505 with a processor 511 to manage the buffer 507 in the receiver 502. The sender 501 comprises one output port 519 and the receiver one input port 520, to which the buffer 507 is associated, to act as interfaces with the link 503 that interconnects them. The sender and receiver may comprise additional ports (not shown in this figure) to interact with other devices within the network 511. The sender 501 may comprise a buffer (not shown in this figure) associated with its output port 519 where data blocks are temporary stored until they are forwarded towards their destination.

The buffer management module 505 may include hardware and software logic to execute instructions, such as the instructions 513-518 stored in the machine-readable storage medium 512. The buffer management module 505 allocates at 513 a plurality of independent credit pools in the buffer 507 at the receiver 502. The buffer management module 505 further allocates at 514 a number of credits from a plurality of credits in which the buffer 507 is divided to each VC 504 from the plurality of VCs 504 in which the link 503 has been virtually divided.

Then, the buffer management module 505 maps at 515 a number of VCs 504 from the plurality of VCs 504 to the previously allocated credit pools. The buffer management module 505 further maps at 516 each VC 504 of the plurality of VCs 504 to a particular traffic class. The buffer management module 505, after determining a particular VC 504 to send the data block and checking if there are enough credits available in at least one of the particular VC 504 and the credit pool to which the particular VC 504 is mapped, sends at 517 a data block to the receiver 502 through the particular VC 504. After that, the buffer management module 505 decrements at 518 a credit counter 506 associated with the respective particular VC 504 and/or the credit pool to which the particular VC 504 is mapped. The receiver 502 also implements a buffer credit counter 508 representing the number of data blocks stored in the buffer 507.

In some examples, the machine readable storage medium 512 further comprise instructions to be executed by the processor 511 in the buffer management module 505 to check the credit counter 506 associated with the particular VC and when the credit counter 506 is under a pre-defined threshold, increment the credit counter 506 associated with the particular VC. When the credit counter 506 associated with the particular virtual channel is above the pre-defined threshold, the machine readable storage medium 512 comprise instructions to be executed by the processor 511 in the buffer management module 505 to increment a credit counter associated with the credit pool to which the particular VC 504 is mapped. In some other examples, when the credit counter 506 associated with the particular VC 504 is above the pre-defined threshold, the machine readable storage medium 512 comprise instructions to be executed by the processor 511 in the buffer management module 505 to increment a credit counter 506 associated with another VC 504 mapped to the same credit pool to which the particular VC 504 is mapped.

In some examples, when there are not enough credits available in the at least one of the particular VC 504 and the credit pool to which the particular VC is mapped to send the received data block, the machine readable storage medium 512 further comprise instructions to send a portion of the data block corresponding to the amount of credits available in the at least one of the particular VC 504 and the credit pool.

The buffer management module 505 may include hardware and software logic to perform the functionalities described above in relation to instructions 513-518. The machine-readable storage medium 512 may be located either in the sender with the processor 511 executing the machine-readable instructions, or remote from but accessible to the sender 501 (e.g., via a computer network) for execution.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

The techniques for sending data between a sender and a receiver that employ a sender managed dynamic buffer allocation mechanism with multiple shared credit pools as described herein improve full link utilization for un-even VC usage by implementing a sender managed policy. The control and management of the credits available on a receiver is performed by the sender. Only the total credits on the receiver, not the credits for each of the VCs, are advertised by the receiver to the sender. These techniques also preserves traffic class isolation by implementing multiple shared credit pools and assigning the VCs to corresponding independent credit pools in the receiver.

1. A method for sending data between a sender and a receiver coupled by a link, comprising:
allocating a number of credit pools in a buffer on the receiver, each credit of each credit pool representing a portion of memory space in the buffer reserved to store data received from the sender;
allocating a number of credits from a plurality of credits to each virtual channel of a plurality of virtual channels;
mapping a number of virtual channels from the plurality of virtual channels to the credit pools;
sendinga data block to the receiver through a particular virtual channel of the plurality of virtual channels when there are enough credits available in at least one of the particular virtual channel and the credit pool to which the particular virtual channel is mapped; and
decrementinga credit counter associated with the corresponding at least one of the particular virtual channel and the credit pool to which the particular virtual channel is mapped.

2. The method of claim 1, further comprising:
upon reception of a credit from the receiver, checking the credit counter associated withwith the particular virtual channel; and
when the credit counter is under a pre-defined threshold, incrementing the credit counter associated with the particular virtual channel.

3. The method of claim 2, further comprising incrementing the credit counter associated with the credit pool to which the particular virtual channel is mapped to when the credit counter associated with the particular virtual channel is above the pre-defined threshold.

4. The method of claim 2, further comprising incrementing a credit counter associated with another virtual channel mapped to the same credit pool to which the particular virtual channel is mapped when the credit counter associated with the particular virtual channel is above the pre-defined threshold.

5. The method of claim 1, further comprising:
prior to sending the data block to the receiver, checking whether there are enough credits available in the credit counter associated with the particular virtual channel for sending the data packet; and
when there are not enough credits available in the credit counter associated with the particular virtual channel, checking whether there are enough credits available in the credit pool to which the particular virtual channel is mapped.

6. The method of claim 1, further comprising sending a portion of the data block corresponding to the amount of credits available in the particular virtual channel and the credit pool when there are not enough credits available in the particular virtual channel and the credit pool to send the entire data block.

7. The method of claim 1, further comprising mapping each virtual channel of the plurality of virtual channels to a particular traffic class.

8. The method of claim 1, further comprising receiving an indication of the total space available in the buffer from the receiver during initialization.

9. The method of claim 1, further comprising a network controller informing the receiver of the number of credit pools to be allocated in the buffer and a respective amount of space to be allocated into the credit pools.

10. The method of claim 1, wherein each virtual channel maps to a maximum of one credit pool.

11. A system comprising:
a sender for connecting to a receiver through a link in a network, the link being divided into a plurality of virtual channels; and
a buffer management module in the sender to manage a buffer on the receiver, the buffer management module to:
allocate a plurality of independent credit pools in the buffer, a credit representing a portion of memory space in the buffer reserved to store data received from the sender;
allocate a number of credits from a plurality of credits to each virtual channel from a plurality of virtual channels;
map a number of virtual channels from the plurality of virtual channels to the credit pools;
send a data block to the receiver through a particular virtual channel of the plurality of virtual channels when there are enough credits available in at least one of the particular virtual channel and the credit pool to which the particular virtual channel is mapped to; and
decrement a credit counter associated with the respective at least one of the particular virtual channel and the credit pool to which the particular virtual channel is mapped to.

12. The system of claim 11, wherein the buffer management module is to, upon initialization of the sender and the receiver, receive from the receiver an indication of the total space available in the buffer.

13. The system of claim 11, wherein the buffer management module is to map each virtual channel of the plurality of virtual channels to a particular traffic class.

14. The system of claim 11, further comprising a network controller to, upon initialization of the sender and the receiver, inform the receiver of the number of credit pools to be allocated in the buffer and a respective amount of space to be allocated into the credit pools.

15. The system of claim 11, wherein the sender comprises a credit counter with the sum of the credits available in the particular virtual channel and the credit pool to which the particular virtual channel is mapped.

16. A non-transitory machine readable storage medium having stored thereon machine readable instructions to cause a computer processor of a sender that is connected to a receiver through a link in a network, the link being divided into a plurality of virtual channels, to:
allocate a plurality of independent credit pools in the buffer;
allocate a number of credits from a plurality of credits in which the buffer is divided to each virtual channel from the plurality of virtual channels;
map a number of virtual channels from the plurality of virtual channels to the credit pools;
map each virtual channel of the plurality of virtual channels to a particular traffic class;
send a data block to the receiver through a particular virtual channel of the plurality of virtual channels when there are enough credits available in at least one of the particular virtual channel and the credit pool to which the particular virtual channel is mapped to; and
decrement a credit counter associated with the respective at least one of the particular virtual channel and the credit pool to which the particular virtual channel is mapped to.

17. The non-transitory machine readable storage medium of claim 16, comprising instructions that, upon reception in the sender of a credit from the receiver, are to:
check the credit counter associated with the particular virtual channel; and
when the credit counter is under a pre-defined threshold, increment the credit counter associated with the particular virtual channel.

18. The non-transitory machine readable storage medium of claim 17, comprising instructions that, when the credit counter associated with the particular virtual channel is above the pre-defined threshold, are to increment the credit counter associated with the credit pool to which the particular virtual channel is mapped to.

19. The non-transitory machine readable storage medium of claim 17, comprising instructions that, when the credit counter associated with the particular virtual channel is above the pre-defined threshold, are to increment a credit counter associated with another virtual channel mapped to the same credit pool to which the particular virtual channel is mapped.

20. The non-transitory machine readable storage medium of claim 16, comprising instructions that, when there are not enough credits available in the at least one of the particular virtual channel and the credit pool to which the particular virtual channel is mapped, are to send a portion of the data block corresponding to the amount of credits available in the at least one of the particular virtual channel and the credit pool.
